(19) United States
(12) Patent Application Publication
(10) Pub. No.: US 2016/0069842 A1
(43) Pub. Date: Mar. 10, 2016

(54) SYSTEM AND METHOD FOR PIPE AND CEMENT INSPECTION USING BOREHOLE ELECTRO-ACOUSTIC RADAR

(71) Applicant: HALLIBURTON ENERGY SERVICES INC., Houston, TX (US)

(72) Inventors: Clovis Bonavides, Houston, TX (US); Burkay Donderici, Houston, TX (US)

(21) Appl. No.: 14/786,007

(22) PCT Filed: May 21, 2013
(86) PCT No.: PCT/US2013/042068

§ 371 Date: Oct. 21, 2015

(51) Int. Cl. G01N 29/24; G01V 3/30; G01N 29/44; E21B 47/00

(52) U.S. Cl. CPC G01N 29/2431; E21B 47/0005; G01V 3/30; G01N 29/2418; G01N 29/4454

(57) ABSTRACT

An example method for pipe inspection in a subterranean formation using borehole electro-acoustic radar may include emitting mechanical energy from a mechanical energy source disposed in a pipe, which may cause the pipe to vibrate. Electromagnetic (EM) energy from an electromagnetic energy source disposed in the borehole may then be transmitted and received. A vibration signature of the medium may be identified by comparing the transmitted EM energy to the received EM energy. This may include determining the phase difference between the transmitted and received EM energy, which can be correlated to the vibration of the pipe.

### BACKGROUND

The present disclosure relates generally to well drilling operations and, more particularly, to systems and methods for borehole pipe and cement inspection using borehole electro-acoustic radar.

During drilling and production operations, it may be necessary to inspect the structural integrity of a downhole pipe and the cement holding the pipe within the formation. Typically, acoustic transmitters and receivers are lowered into the borehole. The transmitters may cause the pipe to vibrate, and the vibration of the pipe may identify structural characteristics of the borehole, including the thickness of the pipe and the cement layer surrounding the pipe. The vibration may be sensed at the acoustic receiver. Unfortunately, the acoustic receivers are susceptible to background noise that may cause errors in measurements.

### FIGURES

Some specific exemplary embodiments of the disclosure may be understood by referring, in part, to the following description and the accompanying drawings.

FIG. 1 illustrates an example inspection system, according to aspects of the present disclosure.

FIG. 2 illustrates an example inspection system, according to aspects of the present disclosure.

FIG. 3 illustrates a response from an example inspection system, according to aspects of the present disclosure.

FIG. 4 illustrates a response from an example inspection system, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present disclosure relates generally to well drilling operations and, more particularly, to systems and methods for pipe and cement inspection using borehole electro-acoustic radar.

Illustrative embodiments of the present disclosure are described in detail herein. In the interest of clarity, not all features of an actual implementation may be described in this specification. It will of course be appreciated that in the development of any such actual embodiment, numerous implementation-specific decisions must be made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the disclosure. Embodiments of the present disclosure may be applicable to horizontal, vertical, deviated, multilateral, u-tube connection, intersection, bypass (drill around a mid-depth stuck fish and back into the well below), or otherwise nonlinear wellbores in any type of subterranean formation. Embodiments may be applicable to injection wells, and production wells, including natural resource production wells such as hydrogen sulfide, hydrocarbons or geothermal wells; as well as borehole construction for river crossing tunneling and other such tunneling boreholes for near surface construction purposes or borehole u-tube pipelines used for the transportation of fluids such as hydrocarbons. Embodiments described below with respect to one implementation are not intended to be limiting.

According to aspects of the present disclosure, systems and method for pipe inspection in a subterranean formation using borehole electro-acoustic radar are described herein. The method may include emitting mechanical energy from a mechanical energy source disposed in a borehole. In certain embodiments, the mechanical energy may comprise sonic or ultrasonic acoustic waves, which may cause a medium within the borehole, such as a pipe, to vibrate with a vibration signature. Electromagnetic (EM) energy from an electromagnetic energy source disposed in the borehole may then be transmitted and received. The EM energy may comprise microwave pulses or laser pulses from a corresponding antenna or optical source.

As a pipe vibrates, the distance between its inner wall and an EM source varies at the frequency of the pipe vibration. If the EM source is emitting a high number of short EM pulses at the time during which the pipe vibration is taking place, for example, the returning pulses will have their phases (which may also be viewed as time of travel) changed as a function of the amplitude of the pipe vibration. Accordingly, if the EM pulses are sent at a frequency greater than twice the highest frequency of pipe vibration, the pipe vibration can be effectively sampled. For instance, if the natural frequency of the first (fundamental) mode of vibration of a pipe is 400 KHz (2.5 microsecond (us) period), emitting a 1000 pulse sequence of 2 gigahertz (GHz) (0.5 nanosecond (ns) period) sinusoidal EM pulses of 2 ns duration separated by 48 ns, and detecting their echoes, will effectively sample the pipe vibration at a rate of 20 MHz—i.e., once every 50 ns—during a time interval of 50 us (1000×50 ns).

As will be described below, a vibration signature of the medium may be identified by comparing the transmitted electromagnetic energy to the received electromagnetic energy. This may include determining the phase difference between the transmitted and received EM energy, which can be correlated to the vibration of the medium or pipe. It may also include determining the amplitude ratio of the transmitted and received electromagnetic energy. Notably, instead of identifying the vibration using an acoustic sensor, which is sensitive to background mechanical noise originating from tool travel, either coupled through the body of the apparatus (instrument) or through the external media or by a combination of these factors, determining a vibration signature using a system composed of an EM energy source and an EM energy receiver may increase the accuracy of the measured vibration signature. The vibration signature may comprise vibration frequency and amplitude as a function of time in a certain time range of measurement. It may also comprise vibration start time, vibration end time, vibration phase and vibration envelope as a function of time.

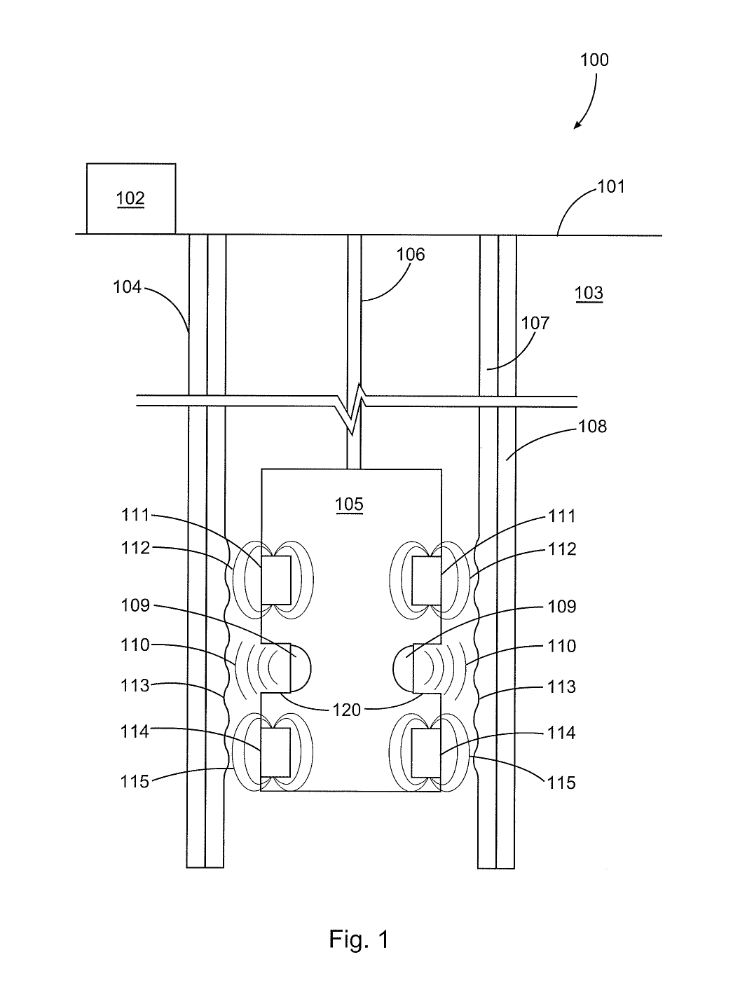

FIG. 1 shows an example inspection system 100, according to aspects of the present disclosure. The inspection system 100 may comprise a downhole tool 105 disposed in a borehole 104. The downhole tool 105 may be suspended in the borehole 104 via a wireline 106, which may provide power from a power source on the surface (not shown) and which may also provide communication to and from a control unit 102 positioned on the surface 101. The control unit 102 may comprise a processor and a memory device coupled to the processor. The memory device may contain instructions that when executed may cause the control unit 102 to issue control signals to the downhole tool 105 and to receive measurements from the downhole tool 105. The control unit 102 may then process the measurements to determine certain characteristics of the borehole 104 and/or its surrounding environment, as will be described below. In certain other embodiments, certain control, power, or processing capabilities may be incorporated into the downhole tool 105.

The downhole tool 105 may be positioned in the borehole 104 proximate to a downhole medium. In the embodiment shown, the downhole medium may comprise a pipe 107 cemented into the borehole 104 with cement layer 108. The pipe 107 may be a production casing, for example, or other pipe that would be appreciated by one of ordinary skill in view of this disclosure. The downhole tool 105 may comprise at least one mechanical energy source 109 coupled thereto. The mechanical energy sources 109 may emit mechanical energy 110 into the pipe 107, cement layer 108, and formation 103, causing vibration 113. In certain embodiments, the mechanical energy sources 109 may be positioned within recessed portions 120 of the downhole tool 105. The recessed portions 120 may function to focus the mechanical energy 110 radially outwards towards the pipe 107, cement layer 108, and formation 103. In other embodiments, these same components may be installed protuberating out (extending outside) of the tool body, pad mounted, or telescopically mounted on mounted on a rotating scanning head. Additionally, any combination of these arrangements may be implemented.

The downhole tool 105 may further comprise at least one EM energy source 111 and at least one EM energy receiver 114. As will be appreciated by one of ordinary skill in the art, in certain embodiments the positions of the EM energy sources and EM energy receivers may be interchanged. Likewise, the EM energy source 111 and EM energy receiver 114 may be combined, or the EM energy source 111 and one EM energy receiver 114 may be dual-function devices that can act as both sources and receivers. The EM energy source 111 may transmit EM energy 112. The EM energy 112 may comprise a plurality of EM pulses, with a pre-determined duration and frequency. The EM energy 112 may be received at the EM energy receivers 114. As will be described below, the vibration 113 of the pipe 107 may alter the characteristics of the EM energy 112 returning to the receiver, effectively modulating the phase of the EM signal. For example, the vibration 113 may alter the phase of the transmitted EM energy 112 before it is received at EM energy receiver 114. In certain embodiments, the EM signal may comprise a plurality of EM pulses, and the amount of phase alteration of the plurality of EM pulses, or the absolute phase alteration on a single EM pulse, may be used to identify certain vibration characteristics of the pipe vibration 113 including the amplitude and frequency of the pipe vibration 113. Similarly, arrival time differences may identify certain vibration characteristics of the pipe vibration 113 including the amplitude and frequency of the pipe vibration 113. Accordingly, by comparing the transmitted EM energy 112 to the received EM energy 115, at least one of the vibration characteristics may be identified.

In certain embodiments, the configuration and placement of the EM energy source 111 and EM energy receiver 114 may be varied with respect to the downhole tool 105 and the mechanical energy source 109. For example, the EM energy source 111 may be angled such that it transmits EM energy at a target area of the pipe 107 adjacent to the mechanical energy source 109. Likewise the EM energy receiver 114 may be angled to the same target area so that it receives EM energy from the same area. The specific angular positions of the sources and receivers may be optimized according to the specific implementation. In certain other embodiments, the EM energy source 111 and EM energy receiver 114 may be moved axially closer to or further from the mechanical energy source to ensure they are accurately measuring the vibration in the pipe 107 caused by the mechanical energy source 109. For example, in ultrasonic applications, where the vibration in the pipe 107 only occurs in the vicinity of the mechanical energy source 109, the EM energy source 111 and EM energy receiver 114 may be moved closer to the source 109. In contrast, in low frequency applications, the EM energy source 111 and EM energy receiver 114 may be spaced further from the source 109.

Certain characteristics of the pipe 107 may affect its vibration signature. For example, the composition (constituent materials), internal and internal/external surface geometries, thickness, acoustic impedance, surface condition (roughness/finish condition), mechanical integrity, etc., of the pipe 107 may affect the vibration signature or pattern. Likewise, other variables may influence the vibration signature, including the acoustic impedance of wellbore fluid and of the medium behind the pipe 107 (natural rocks, cement, fluids or a combination thereof), and the geometry of the interfaces between the different media (interfaces between borehole, pipe, cement and formation). The acoustic energy attenuation in the wellbore fluid and the spectral content of the source signals will also affect the ability of the sound source to cause the pipe 107 to vibrate. Accordingly, accurately identifying the vibration signature of the pipe 107 may allow for an accurate determination of some of these variables, which may be otherwise difficult to determine. Additional geometrical or mechanical aspects of the pipe 107 may also be identifiable through vibration and pulse echo (EM signal travel time) analysis. These aspects may include deformations of the pipe 107 such as holes and broken, bent, relatively thinner, thicker, rougher, or corroded sections.

In certain embodiments, the mechanical energy source 109 may comprise an acoustic source, the mechanical energy 110 may comprise an acoustic wave, the EM energy sources 111 and EM energy receivers 114 may comprise antennae, and the transmitted EM energy 112 may comprise a plurality of high-frequency EM pulse sequences, such as pulses in the microwave-range. The acoustic wave 110 may have pre-determined spectral frequency characteristics, and may cause the pipe 107 to vibrate 113. The phase, arrival time, or amplitude of the transmitted EM pulses 112 may be altered by the vibration 113 of the pipe 107 such that the vibration signature of the pipe 107 may be determined by comparing the transmitted EM pulses 112 to the received EM pulses 115.

In certain other embodiments, the mechanical energy source 109 may comprise an acoustic source operating in the sonic and/or ultrasonic frequency range; the mechanical energy 110 may comprise an acoustic wave; the EM energy sources 111 and EM energy receivers 114 may comprise optical sources and optical receivers, respectively; and the transmitted EM energy 112 may comprise a plurality of laser pulses. The acoustic wave 110 may have a pre-determined frequency spectrum, and may cause the pipe 107 to vibrate 113. In certain embodiments, the frequency spectrum may be selected to make the pipe 107 vibrate in at least one preferred mode. The phase of the transmitted laser pulses 112 may be altered or modulated by the vibration 113 such that the vibration characteristics may be determined by comparing the transmitted EM laser pulses 112 to the received EM microwave pulses 115 using waveform processing techniques that would be appreciated by one of ordinary skill in the art in view of this disclosure.

In certain embodiments, the downhole tool 105 may not have a mechanical energy source, or may make measurements without generating acoustic energy in the borehole. For example, pipe vibrations might originate from a flow of fluids—e.g., oil or water—within areas located behind the pipe, such channels or fractures in the cement or formation, a micro-annulus at the pipe cement interface, or any other fluid migration channel or pathway. In certain instances where the flow of fluid outside of the pipe is unwanted or unintentional, these fluid flows may be referred to as “leaks.” The downhole tool may be used to detect certain leaks, for example, by turning off or otherwise not triggering the mechanical energy source 109 and placing the downhole tool 105 in a static position, such that all or most of the pipe's vibration is caused by a leak. The EM energy sources 111 and EM energy receivers 114 may then be used to identify 1) if there is a leak (i.e., is the pipe vibrating) and 2) the vibration signature of the pipe, which may provide information regarding the type and location of the leak. The downhole tool 105 also may be used to determine fluid flow within the pipe 107 using similar configurations.

For example, the downhole tool 105 may have its mechanical energy source disengaged or otherwise turned off when it is being used to detect a flow of fluid proximate to a pipe, including a leak. The EM energy sources 111 may transmit EM energy when the mechanical energy source 109 is disengaged, and the EM energy receivers 114 may received the EM energy. The received EM energy may have been altered by the vibration of the pipe 107 in response to the flow of fluid or leak. By comparing the transmitted EM energy to the received EM energy, the vibration signature of the pipe 107 may be determined. The vibration signature may then be used to identify at least one flow of fluid proximate to the medium.

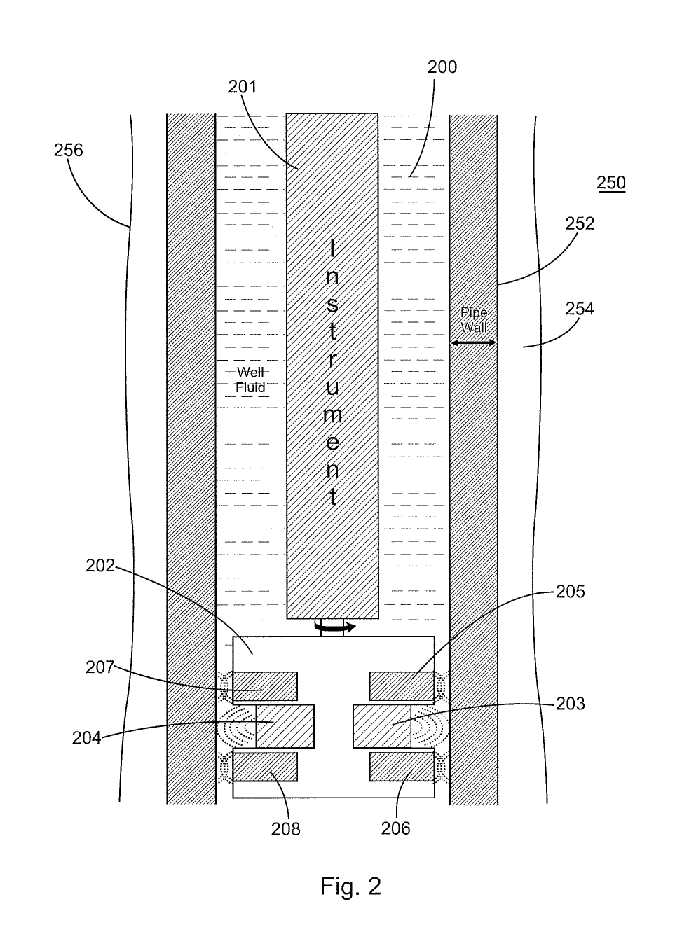

FIG. 2 illustrates an example downhole tool 200, according to aspects of the present disclosure. As can be seen, the tool 200 is disposed in a wellbore 256 within a formation 250. A pipe 252 may be disposed within borehole 256 and secured within the borehole 256 via cement layer 254. In contrast to the stationary tool shown in FIG. 1, tool 200 includes a stationary portion 201 and a rotating portion 202. A tool with a rotating portion may be used, for example, when azimuthal resolution is required. The rotating portion 202 may comprise a scanning head on which mechanical energy sources 203 and 204 and EM energy transmitter/receivers 204-207 are disposed. Although the mechanical energy sources 203 and 204 and EM energy transmitter/receivers 204-207 are shown coupled to the rotating portion 202 some of the mechanical energy sources 203 and 204 and EM energy transmitter/receivers 204-207 may be disposed on the stationary portion of 201 of the tool.

In operation, the rotating portion 202 may rotate the mechanical energy sources 203 and 204 and EM energy transmitter/receivers 204-207 around the interior surface of the pipe, scanning the various portions of the pipe 252. In the embodiment shown the mechanical energy sources 203 and 204 may transmit mechanical energy, such as acoustic waves, at the pipe 252. The EM energy transmitter/receivers 204-207 may be placed as close as possible to the pipe 252, without touching it and without producing any unacceptable effects to the measurement. A sequence of short high-frequency EM pulses may be transmitted by EM energy transmitter/receivers 204-207 and the reflected pulses may be received at EM energy transmitter/receivers 204-207 and recorded. The transmitted pulses may then be compared to the reflected/received pulses to determine a vibration signature of the pipe. In certain embodiments, the EM energy transmitter/receivers 204-207 may comprise directionally focused antennas, or antennas that are tuned to sense certain frequency ranges.

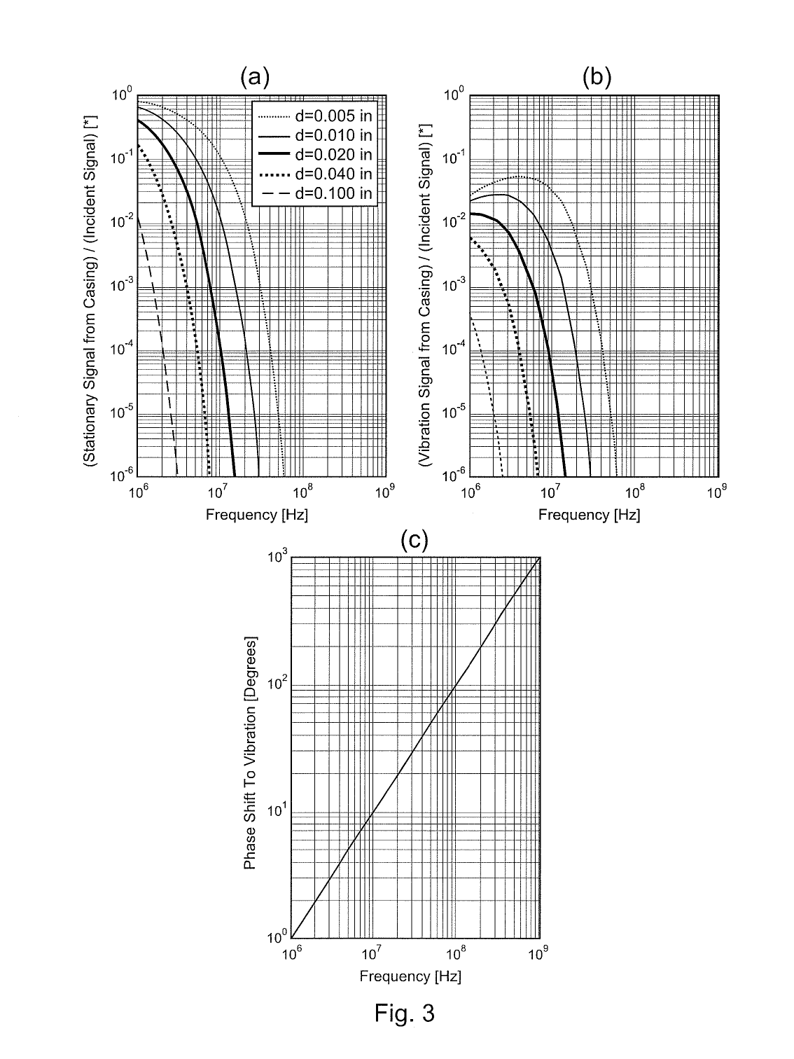

FIG. 3 illustrates differing signal levels and sensitivities for a downhole tool comprising antennae, plotted with different frequency excitations and different distances d from the pipe. Even though the plot was made as a function of frequency, it can also be used in the interpretation of a time-based system with the use of a Fourier Transform. Graph a of FIG. 3 plots the percentage of stationary signal attenuation versus the frequency of the incident signal, according to different distances d of the tool from the pipe. Graph b of FIG. 3 plots the percentage of the vibrating signal attenuation versus the frequency of the incident signal, according to the different distances d of the tool from the pipe. As can be seen, signal attenuation is typically lower at lower frequencies, but is improved the closer the tool is to the pipe. Graph c, in contrast, plots the phase shift due to vibration versus the frequency of the incident signal, and illustrates that the phase shift is more pronounced at higher frequencies. Accordingly, the distance of the tool from the pipe and the frequency of the EM energy transmitted from the tool can be selected to maximize the response. For example, by using the relationships tabulated in FIG. 3, it is possible to solve for the distance to the pipe. This can be achieved by determining a ratio of the stationary signal from the pipe to the incident signal and comparing it to the tabulated values. Alternatively, ratio of measurements that are taken at multiple frequencies, or ratio of the vibration signal to the incident signal can also be used to make the same determination. Such measurements may also carry useful information about the well fluid, like its acoustic attenuation and dispersion characteristics.

In certain other embodiments, after the vibration of the pipe is measured, a geomechanical interpretation may be applied to recover the information carried by the pipe vibration. The geomechanical interpretation may involve analytical expressions that relate transient or stationary properties of the vibration to the properties of the pipe or cement. For example, the thickness or density of the pipe or cement layers is known to alter the frequency response. The acoustic impedance (Z) of the material behind the pipe also affects the signature of the returning EM pulses. As would be appreciated by one of ordinary skill in the art in view of this disclosure, Z-maps can be calculated or inferred from the pipe vibration signature to help identify the presence of cement and the degree of bonding of the cement to the pipe, thus providing important information about the isolation between adjacent geological strata at the borehole interface. Modeling algorithms may also be employed to aid the interpretation, for example, by solving an optimization problem to minimize the difference between modeled vibration response and the measured vibration response.

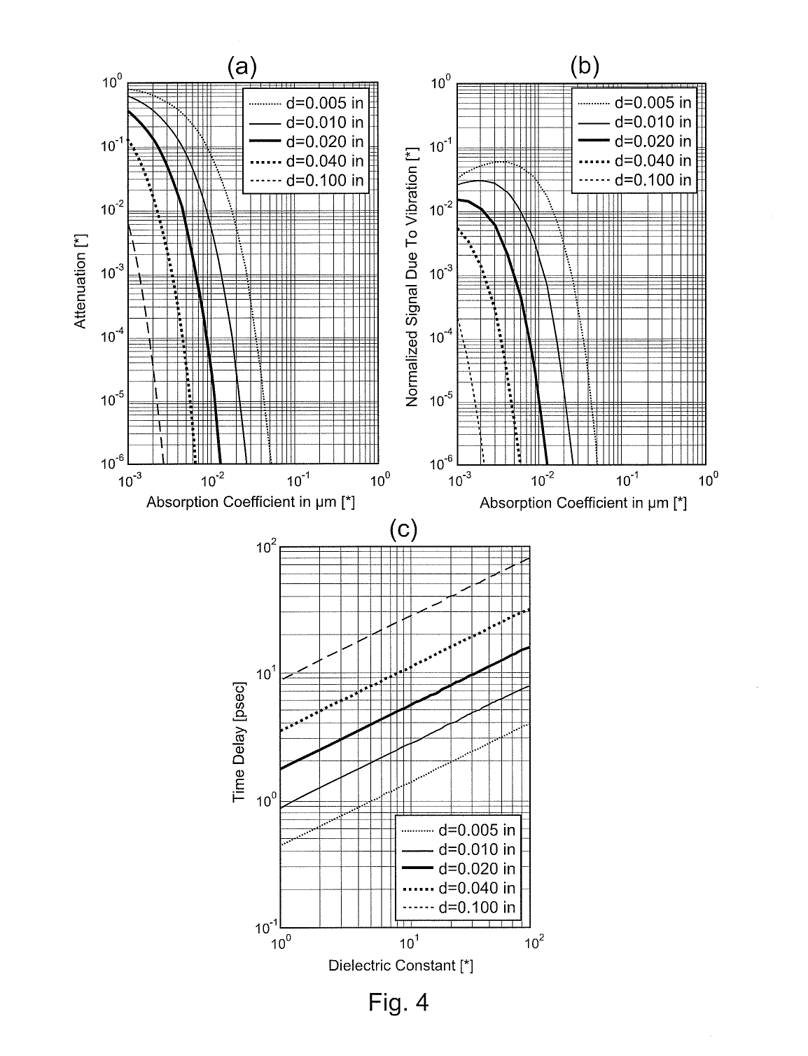

In certain other embodiments, the EM energy transmitter/receivers 204-207 may comprise directionally focused optical sources/receivers. FIG. 4 illustrates differing signal levels and sensitivities for a downhole tool comprising antennae, plotted against different absorption coefficients of the optical receivers and different distances d from the pipe. Graph a of FIG. 4 plots the percentage of stationary signal attenuation versus the absorption coefficient of the optical receiver, according to different distances d of the tool from the pipe. Graph b of FIG. 4 plots the percentage of the vibrating signal attenuation versus the absorption coefficient of the optical receiver, according to different distances d of the tool from the pipe. As can be seen, signal attenuation is typically lower at smaller absorption coefficients, but is improved the closer the tool is to the pipe. Graph c, in contrast, plots the phase shift due to vibration versus the dielectric constant of the optical receiver, and illustrates that the phase shift is more pronounced at higher dielectric constant values. Accordingly, the distance of the tool from the pipe and the absorption coefficients of the optical receivers and transmitters can be selected to maximize the response.

In certain embodiments, at least one of the mechanical energy source, EM energy source, or EM energy receiver can be placed in a housing or on a pad device that can be mechanically moved towards the wall of the pipe 252, thus reducing the distance between the rotation portion of the measurement device 202 and the wall of the pipe 252. This may increase the absolute and relative signal strength from the pipe 252 and as a result improve the accuracy of the downhole tool. Furthermore, the rotating portion 202 may be stopped while taking the measurement to reduce the mechanical noise to achieve higher signal to noise ratio (SNR). In this case, rotation may be applied in between multiple measurements to provide angular coverage. Background measurements may also take place at intervals during which the mechanical energy source is inactive to further improve SNR figures.

In certain embodiments, when optical sources and receivers are used, the Doppler Effect can be utilized to determine vibration characteristics of the pipe 252. For example, since optical signals may be modulated by the movement of the pipe 252, changes in the received EM signal frequencies can be measured. According to certain embodiments, equation 1 may be used to determine certain vibration parameters of the pipe 252.

ω_{eq}=ωₑₘ−kd_{vib}ω_{ac} cos(t₀ω_{ac}) (1)

Notably, ωₑₘ may comprise the optical frequency of the transmitted optical signal and ω_{eq} may comprise the optical frequency of the received optical signal, meaning the second term on the right hand side in equation (1) comprises the deviation in the optical frequency due to the vibration in the pipe wall. As it can be seen from the formula, deviation may be proportional to k, the spatial frequency of the EM signal; d_{vib}, the pipe vibration amplitude; and ω_{ac}, the acoustic frequency at the pipe. When two of these three parameters are known, the third can be found by using a measurement of deviation. As an example, if k and ω_{ac} is known, d_{vib} can be found. In certain embodiments, ω_{ac} can be found using the profile of the deviation as a function of time.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. A method for pipe inspection in a subterranean formation, comprising:
emitting mechanical energy from a mechanical energy source disposed in a borehole, wherein the mechanical energy causes a medium within the borehole to vibrate according to a first vibration signature; and
transmitting first electromagnetic (EM) energy from an EM energy source disposed in the borehole;
receiving the first EM energy; and
identifying the first vibration signature of the medium by comparing the transmitted first EM energy to the received first EM energy.

2. The method of claim 1, wherein the EM energy source comprises an array of antennae.

3. The method of claim 1, wherein the EM energy source comprises electric or magnetic dipoles.

4. The method of claim 3, wherein the electric or magnetic dipoles comprise at last one of a Horn antenna, a phase array, and a parabolic antenna.

5. The method of claim 1, wherein the EM energy source comprises a microwave source, and the transmitted first EM energy comprises microwave energy pulses.

6. The method of claim 1, wherein the EM energy source comprises an optical source, and the transmitted first EM energy comprises laser pulses.

7. The method of claim 1, wherein identifying the first vibration signature of the medium by comparing the transmitted first EM energy to the received first EM energy comprises identifying at least one of a phase shift, an arrival time, and an amplitude ratio between the transmitted first EM energy and the received first EM energy.

8. The method of claim 6, wherein identifying the first vibration signature of the pipe comprises solving for d_{vib} in the following equation:
ω_{eq}=ωₑₘ−k*d_{vib}*ω_{ac}*cos(t₀*ω_{ac}),
where ωₑₘ comprises the transmitted optical frequency of the laser pulses, ω_{eq} comprises the received optical frequency of the laser pulses, ω_{ac} comprises the acoustic frequency at the pipe, d_{vib} comprises the pipe vibration amplitude, and k comprises spatial frequency of the first EM energy.

9. The method of claim 1, further comprising introducing a downhole tool into the borehole, wherein the mechanical energy source and the EM energy source are coupled to the downhole tool.

10. The method of claim 9, wherein at least one of the EM energy source and the mechanical energy source is positioned on a rotating portion of the tool.

11. The method of claim 9, further comprising positioning the mechanical source and the EM energy source proximate to a pipe installed within the bore using a cement layer.

12. The method of claim 11, further comprising determining at least one geometrical or mechanical property of the cement layer or the pipe using the first vibration signature.

13. The method of claim 12, wherein determining at least one geometrical or mechanical property of the cement or the pipe using the first vibration signature comprises the use of at least one of an analytical expression or an optimized modeling function.

14. The method of claim 1, further comprising:
transmitting second EM energy from the EM energy source;
receiving the second EM energy; and
identifying a second vibration signature of the medium by comparing the transmitted second EM energy to the received second EM energy, wherein the second vibration signature identifies at least one flow of fluid proximate to the medium.

15. An apparatus for pipe inspection in a subterranean formation, comprising:
a downhole tool;
at least one mechanical energy source coupled to the downhole tool;
at least one electromagnetic (EM) energy source coupled to the downhole tool;
at least one EM energy receiver coupled to the downhole tool;
at least one processor in communication with the at least one mechanical energy source and the at least one EM energy source, wherein the processor is coupled to at least one memory element containing a set of instruction that when executed by the at least one processor cause the processor to:
signal the at least one mechanical energy source to emit mechanical energy into a pipe, wherein the mechanical energy causes the pipe to vibrate according to a first vibration signature;
signal the at least one EM energy source to transmit first EM energy;
signal the at least one EM energy receiver to receive the transmitted first EM energy; and
determine the first vibration signature of the pipe by comparing the transmitted first EM energy to the received first EM energy.

16. The system of claim 15, wherein the EM energy source comprises an array of antennae.

17. The system of claim 15, wherein the EM energy source comprises electric or magnetic dipoles.

18. The system of claim 17, wherein the electric or magnetic dipoles comprise at last one of a Horn antenna, a phase array, and a parabolic antenna.

19. The system of claim 15, wherein the EM energy source comprises a microwave source, and the transmitted EM energy comprises microwave energy pulses.

20. The system of claim 15, wherein the EM energy source comprises an optical source, and the transmitted first EM energy comprises laser pulses.

21. The system of claim 15, wherein comparing the transmitted first EM energy to the received first EM energy comprises identifying at least one of a phase shift, an arrival time, and an amplitude ratio between the transmitted first EM energy and the received first EM energy.

22. The system of claim 20, wherein the vibration signature of the pipe is determined by solving for d_{vib} in the following equation:
ω_{eq}=ωₑₘ−k*d_{vib}*ω_{ac}*cos(t₀*ω_{ac}),
where ωₑₘ comprises the transmitted optical frequency of the laser pulses, ω_{eq} comprises the received optical frequency of the laser pulses, ω_{ac} comprises the acoustic frequency at the pipe, d_{vib} comprises the pipe vibration amplitude, and k comprises spatial frequency of the first EM energy.

23. The system of claim 15, wherein at least one of the EM energy source and the mechanical energy source is positioned on a rotating portion of the downhole tool.

24. The system of claim 15, wherein the set of instruction that when executed by the at the processor further cause the processor to determine at least one geometrical or mechanical property of the borehole using the first vibration signature.

25. The system of claim 15, wherein the set of instruction further cause the processor
cause the at least one EM energy source to transmit second EM energy;
cause the at least one EM energy receive the transmitted second EM energy; and
determine a second vibration signature of the pipe by comparing the transmitted second EM energy to the received second EM energy, wherein the second vibration signature identifies at least one flow of fluid proximate to the pipe.
